(19) United States
(12) Patent Application Publication
(10) Pub. No.: US 2025/0260107 A1
(43) Pub. Date: Aug. 14, 2025

(54) FLEXIBLE LAMINATES INCLUDING POLYURETHANE ADHESIVE COMPOSITIONS AND ENERGY STORAGE DEVICES INCLUDING THE SAME

(71) Applicant: H.B. Fuller Company, St. Paul, MN (US)

(72) Inventors: Wayne G. Eklund, Scandia, MN (US); Albert M. Giorgini, Lino Lakes, MN (US)

(21) Appl. No.: 18/854,844

(22) PCT Filed: Apr. 7, 2023
(86) PCT No.: PCT/US2023/065488

§ 371 Date: Oct. 7, 2024

Related U.S. Application Data
(60) Provisional application No. 63/362,639, filed on Apr. 7, 2022.

(51) Int. Cl. H01M 50/231; B32B 7/12; B32B 15/20; H01M 10/0525; H01M 50/224; H01M 50/227

(52) U.S. Cl. CPC H01M 50/231; B32B 7/12; B32B 15/20; H01M 10/0525; H01M 50/224; H01M 50/227; B32B 2250/03; B32B 2250/40; B32B 2457/10

(57) ABSTRACT

The invention features a flexible laminate including a first plastic layer, a polyurethane adhesive composition, and a metal layer bonded to the plastic layer through the polyurethane adhesive composition, the polyurethane adhesive composition comprising a reaction product of a first part comprising an isocyanate terminated polyurethane prepolymer, and a second part comprising an epoxy resin having an equivalent weight of at least 300 g/eq. These flexible laminates have the high temperature resistance and chemical resistance necessary to package challenging materials

[symbol]

### CROSS REFERENCE TO RELATED APPLICATIONS

This application claims the benefit of U.S. Provisional Application No. 63/362,639, filed Apr. 7, 2022, which is incorporated herein.

### BACKGROUND

Flexible laminates are widely used in a variety of areas including food packaging.

Flexible laminates are often comprised of more than one layer of material adhered together. These laminates are typically constructed to have a strong cured bond that are resistant to delaminating stresses resulting from stresses imposed on the laminate when the laminate is formed into other articles such as pouches and bags (e.g., by heat welding) or when the laminate is used. These stresses can include exposure to heat, cold, and humidity and exposure to a variety of compositions that are often stored in bags made from such laminates including, e.g., food products.

Containers (e.g., pouches, bags, etc.) formed from such laminates can also be used to package other items including vehicle fluids, industrial chemicals and as the pouch (i.e. outer layer) of pouch style lithium ion batteries.

Pouch style lithium ion batteries have increased in popularity as they provide a simple, flexible and lightweight battery. Laminates that form the pouch of lithium ion batteries often include a composite three-layer laminate formed by an outer layer, a middle metal foil layer, and an inner heat seal layer. It is particularly difficult to form a bond between the outer layer (e.g. nylon) and the middle metal foil layer (e.g. aluminum foil).

Polyurethane adhesives have been used in flexible laminates. Polyurethane adhesive compositions are often derived from a two-part system in which a first part (e.g., a polyisocyanate) is reacted with a second part (e.g., a polyol).

There is a need for polyurethane adhesive compositions that exhibit strong adhesive properties to both metal foil and various plastics, and further have the high temperature resistance and chemical resistance necessary to package challenging materials e.g., energy storage devices such as lithium ion batteries.

### SUMMARY

In one aspect, the invention features flexible laminate including a first plastic layer, a polyurethane adhesive composition, and a metal layer bonded to the first plastic layer through the polyurethane adhesive composition, the polyurethane adhesive composition including a reaction product of a first part including an isocyanate terminated polyurethane prepolymer, and a second part including greater than 20% by weight based on the weight of the second part of an epoxy resin having an equivalent weight of at least 300 g/eq.

In another aspect, the invention features a flexible laminate including a first plastic layer, a polyurethane adhesive composition, and a metal layer bonded to the first plastic layer through the polyurethane adhesive composition, the polyurethane adhesive composition including a reaction product of, from 75% by weight to 90% by weight of an isocyanate terminated polyurethane prepolymer, and from 10% by weight to 25% by weight of an epoxy resin having an equivalent weight of at least 300 g/eq, wherein the weight percentages are based on 100% solids

In one embodiment, the isocyanate terminated polyurethane prepolymer comprises the reaction product of a polyether polyol and polyisocyanate. In another embodiment, the polyurethane adhesive composition has an NCO:OH ratio of from 3:1 to 1.1:1, or even from 2:1 to 1.1:1

In another embodiment, the epoxy resin is aromatic and has an epoxy functionality of at least 2. In a different embodiment, epoxy resin further has an OH functionality of greater than 2. In one embodiment, the epoxy is a solid at room temperature and is derived from a liquid epoxy and bisphenol A.

In one embodiment, the metal layer is selected from the group consisting of aluminum, aluminum alloys, stainless steel, copper and titanium. In another embodiment, the metal layer is selected from the group consisting of aluminum and aluminum alloys. In one embodiment, the first plastic layer is selected from the group consisting of polyamide, polyimide, polyester, epoxy, acrylic, fluoropolymers, polyurethane, silicone, phenolic resin, polycarbonate, and copolymers thereof. In another embodiment, the first plastic layer is selected from the group consisting of polyamide and polyester. In a different embodiment, the first plastic layer is nylon and the metal layer is an aluminum foil.

In a different embodiment, the flexible laminate further comprises a second plastic layer. In one embodiment, the first plastic layer is nylon and the second plastic layer is polypropylene.

In one embodiment, the invention features a package including a flexible laminate including the first plastic layer, the polyurethane adhesive composition layer, the metal layer, a second adhesive composition, and the second plastic layer arranged in sequence from the outside to the inside of the package. In another embodiment, the second adhesive composition is the polyurethane adhesive composition. In another embodiment, the second plastic layer is selected from the group consisting of cast polypropylene and metalized polypropylene.

In another embodiment, the invention features a package formed from any of the preceding flexible laminates. In one embodiment, the package comprises the inventive flexible laminate and an energy storage device, or even a lithium ion battery.

In one aspect, the invention features a packaged lithium-ion battery including a lithium-ion battery, and a pouch surrounding the lithium-ion battery, the pouch including a flexible laminate comprising a first plastic layer, a polyurethane adhesive composition, a metal foil layer, a second adhesive composition, and a second plastic layer arranged in sequence from the outside to the inside, the polyurethane adhesive composition including the reaction product of a first part comprising an isocyanate terminated polyurethane prepolymer, and a second part comprising an epoxy resin having an equivalent weight of at least 300 g/eq.

In another aspect, the invention features a method of making a flexible laminate including obtaining a polyurethane adhesive composition including a first part including an isocyanate terminated polyurethane prepolymer and a solvent, and
a second part including an epoxy resin having an equivalent weight of at least 300 g/eq and a solvent, mixing the first part and the second part of the polyurethane adhesive composition together, applying the polyurethane adhesive to a substrate selected from the first plastic layer and the metal layer, laminating the remaining substrate into place, such that the metal layer is bonded to the plastic layer through the polyurethane adhesive composition.

In one embodiment, the first part has a solids content of from 50% by weight to 90% by weight and the second part has a solids content of from 25% by weight to 75% by weight. In another embodiment, the first part and the second part include a solvent selected from the group consisting of acetone, methyl ethyl ketone, methyl isobutyl ketone, ethyl acetate and combinations thereof.

The invention features a polyurethane adhesive composition that exhibits good adhesion to flexible substrates such as flexible polymer films, metallized polymer films, and metal foils. The polyurethane adhesive composition further provides bonds that have strong adhesion at high temperatures and good chemical resistance. These features make the polyurethane adhesive compositions especially suitable for forming the outer covering of energy storage devices e.g. pouch style lithium ion batteries.

Other features and advantages will be apparent from the following description of the preferred embodiments and from the claims.

### BRIEF DESCRIPTION OF THE DRAWINGS

The drawings are intended to be illustrative and are not limiting.

FIG. 1 is a cross-section view of the flexible laminate of the invention including the first plastic layer (10), the metal layer (15) and a polyurethane adhesive composition layer (8).

FIG. 2 is a cross-section view of the flexible laminate of the invention further including a second plastic layer (20) and a second adhesive composition layer (12).

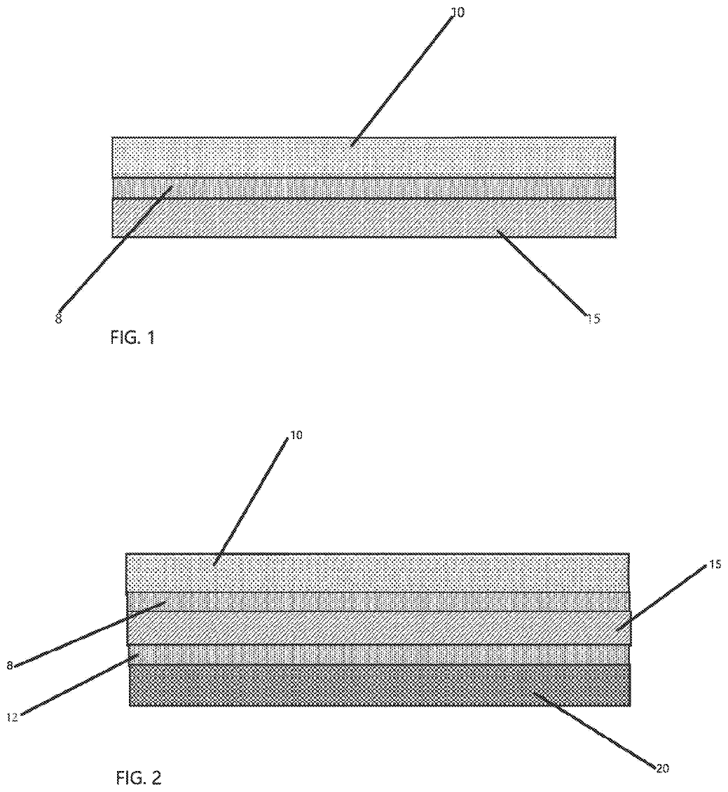

### DETAILED DESCRIPTION

The invention features a flexible laminate including a first plastic layer, a polyurethane adhesive composition, and a metal layer bonded to the first plastic layer through the polyurethane adhesive composition, the polyurethane adhesive composition including the reaction product of a first part including an isocyanate terminated polyurethane prepolymer, and a second part including an epoxy resin having an equivalent weight of at least 300 g/eq. The second part can include greater than 20% by weight of the epoxy resin.

The invention further features a flexible laminate including a first plastic layer, a polyurethane adhesive composition, and a metal layer bonded to the first plastic layer through the polyurethane adhesive composition, the polyurethane adhesive composition including the reaction product of, from 75% by weight to 90% by weight of an isocyanate terminated polyurethane prepolymer, and from 10% by weight to 25% by weight of an epoxy resin having an equivalent weight of at least 300 g/eq. wherein the weight percentages are based on 100% solids.

The invention further features a packaged energy storage device include an energy storage device and a package surrounding the energy storage device, the package including a flexible laminate comprising a first plastic layer, a polyurethane adhesive composition, a metal foil layer, a second adhesive composition, and a second plastic layer arranged in sequence from the outside to the inside, the polyurethane adhesive composition including the reaction product of a first part comprising an isocyanate terminated polyurethane prepolymer, and a second part comprising an epoxy resin having an equivalent weight of at least 300 g/eq. The polyurethane adhesive composition can alternatively include the reaction product of, from 75% by weight to 90% by weight of an isocyanate terminated polyurethane prepolymer, and from 10% by weight to 25% by weight of an epoxy resin having an equivalent weight of at least 300 g/eq, wherein the weight percentages are based on 100% solids.

The energy storage device can be a lithium-ion battery.

### Flexible Laminate

The invention features a flexible laminate including a first plastic layer, a polyurethane adhesive composition, and a metal layer bonded to the first plastic layer through the polyurethane adhesive composition, the polyurethane adhesive composition including the reaction product of a first part including an isocyanate terminated polyurethane prepolymer, and a second part including an epoxy resin having an equivalent weight of at least 300 g/eq.

The flexible laminate can further include additional layers.

The various layers of the flexible laminate can be surface treated to enhance adhesion using a variety of methods including, e.g., corona treatments, chemical treatments, flame treatments, and combinations thereof.

### First Plastic Layer

The first plastic layer is the outward facing layer of the laminate when the laminate is used to form a flexible package. The function of the first plastic layer is to prevent the penetration of air, especially oxygen into the flexible package. The first plastic layer can be a film. The first plastic layer can be a biaxially oriented film.

The first plastic layer can be selected from the group consisting of polyamide (e.g. nylon), polyimide, polyester, epoxy, acrylic, fluorine, polyurethane, silicone, phenolic resin, polycarbonate, copolymers thereof (including copolymers of materials in the list and copolymers of other materials with materials in the list) and mixtures thereof.

The first plastic layer can be selected from the group consisting of polyamide (e.g. nylon), polyester and polyphenylene sulfide (PPS). The polyamide can be selected from the group consisting of nylon 6, nylon 66, nylon 10 and copolymers thereof. The polyester can be selected from the group consisting of polyethylene terephthalate, polybutylene terephthalate, polyethylene naphthalate and polybutylene naphthalate. The polyphenylene sulfide (PPS) can be biaxially oriented PPS.

In a preferred embodiment, the plastic layer is nylon, or even biaxially oriented nylon. The first plastic layer can include various fillers to improve its properties e.g., glass fibers, carbon fibers, etc.

The first plastic layer can have a thickness of from 5 to 100, 8 to 75, or even 10 to 50 microns.

### Metal Layer

The metal layer is an inner facing layer of the laminate (i.e. it faces the interior of the flexible package) when the laminate is used to form a flexible package. The function of the metal layer is to prevent the migration of moisture into the package and further to prevent external damage. The metal layer can be a metal foil.

The metal layer can be selected from the group consisting of aluminum, aluminum alloys (e.g. aluminum iron, aluminum manganese, etc.), stainless steel, copper and titanium.

The metal layer is preferably an aluminum foil.

The metal layer can have a thickness of from 5 to 100, 15 to 75, 20 to 60, or even 20 to 40 microns.

### Second Plastic Layer

The flexible laminate can include a second plastic layer. The second plastic layer is located such that the metal layer is between the first plastic layer and the second plastic layer. However, there can be additional layers located between the metal layer and the second plastic layer. The second plastic layer can have electrolyte resistant properties and can form a heat seal. The flexible package can be formed by heat sealing two portions of the flexible laminate, with the second plastic layers facing each other around the perimeter of the two pieces of flexible laminate.

The second plastic layer can comprise more than one layer. The second plastic layer can be selected from the group consisting of polyethylene, polypropylene, olefin copolymers (e.g., propylene ethylene, etc.), olefin elastomers (POE), ethylene vinyl acetate, metallized versions thereof and combinations thereof. The second plastic layer is preferably a polyolefin film.

The second plastic layer can be selected from the group consisting of cast polypropylene and metalized polypropylene. The second plastic layer can have a thickness of 5 to 150, or even 15 to 125 microns.

### Additional Layers

The flexible laminate can include additional layers. The additional layers can include thermoplastic polyurethane layers, additional foil layers, anti-corrosive coatings, ink coatings, coatings including pigment, etc. The additional layers can be bonded with the polyurethane adhesive composition. Alternatively, the additional layer/s can be bonded with a second adhesive composition. The additional layers/s can be applied using a carrier material of some sort (e.g. solvent, water, etc.) that evaporates once the layer is applied. Alternatively, the additional layer/s can be applied in a melted state, forming a bond as they cool.

### Polyurethane Adhesive Composition

The polyurethane adhesive composition is a two-part polyurethane adhesive composition. The first part and the second part are kept separate prior to application and are combined just before application. Once combined the equivalent ratio of isocyanate groups from the prepolymer (first part) and the hydroxyl groups from the epoxy/optional polyols (second part) is from 3:1 to 1.2:1, from 2:1 to 1.2:1 or even from 1.5:1 to 1.2:1.

Once combined the polyurethane adhesive composition can be cured at room temperature, or at a higher temperature to improve the rate and amount of cure.

The first part includes an isocyanate terminated polyurethane prepolymer. The first part can further include solvent, additional isocyanates and various additives. The first part can have a calculated solids content of from 50% by weight to 90% by weight, or even 60% by weight to 85% by weight.

The second part comprises an epoxy resin having an equivalent weight of at least 300 g/eq. The second part can further include solvent, additional polyols and various additives. The second part can have a calculated solids content of from 25% by weight to 75% by weight, or even from 35% by weight to 65% by weight.

The polyurethane adhesive composition based on 100% solids i.e. once the first part and the second part are combined and the solvent has evaporated, can include from 5% by weight to 35% by weight, from 7% by weight to 30% by weight, from 10% by weight to 25% by weight, from 12% by weight to 25% by weight, or even from 10% by weight to 25% by weight of the epoxy resin and from 50% by weight to 95% by weight, from 65% by weight to 95% by weight, from 70% by weight to 93% by weight, or even from 75% by weight to 90% by weight of the polyurethane prepolymer.

The polyurethane adhesive composition exhibits a 180° peel adhesion at 23° C. of at least 3 N/15 mm, at least 3.5 N/15 mm, or even at least 4 N/15 mm and a 180° peel adhesion at 120° C. of at least 2 N/15 mm, at least 2.5 N/15 mm, or even at least 3 N/15 mm when tested according to the 180° peel adhesion test method.

### Polyurethane Prepolymer

The polyurethane prepolymer of the polyurethane adhesive composition includes the reaction product of a polyol and a polyisocyanate. The polyurethane prepolymer is isocyanate terminated.

The polyurethane prepolymer can include primarily polyether polyol. The polyol portion of the polyurethane prepolymer can include greater than 50% by weight polyether polyol, greater than 60% by weight polyether polyol, greater than 70% by weight polyether polyol, greater than 80% by weight polyether polyol, from 60% by weight to 100% by weight polyether polyol, or even from 70% by weight to 100% by weight polyether polyol.

Based on 100% solids, the NCO (isocyanate group) content of the polyurethane prepolymer can be from 1.0% by weight to 20% by weight, from 1.0% by weight to 10% by weight, from 1.0% by weight to 7% by weight, or even from 2.0% by weight to 4.0% by weight.

The polyurethane prepolymer can have a NCO/OH ratio of from 1.2/1 to 5/1, or even from 1.2/1 to 3/1.

### Polyol

The polyurethane prepolymer include the reaction product of a polyol component and a polyisocyanate. The second part can also include polyols.

Useful classes of polyols include, e.g., polyether polyols, polyester polyols, specialty polyols (e.g., polybutadiene polyols, hydrogenated polybutadiene polyols, polycarbonate polyols, acrylic polyols, alkylene oxide adducts of polyphenols, polyhydroxy sulfide polymers, epoxy polyols, opened ring epoxy polyols) and combinations thereof.

The polyols can have a functionality of at least 2, greater than 2 or a combination thereof.

Suitable polyols include, ethane-1,2-diol, propane diols (e.g., 1,2-propanediol and 1,3-propanediol), butane diols (e.g., 1,2-butanediol, 1,3-butanediol, and 1,4-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, 1,4-cyclohexanedimethanol, 1,4-cyclohexanediol, dimer diols, glycerol, tetramethylene glycol, polytetramethylene ether glycol, 3-methyl-1,5-pentanediol, 1,9-nonanediol, 2-methyl-1.8-octanediol, trimethylolpropane, pentaerythritol, sorbitol, glucose, aromatic polyols and mixtures thereof.

Suitable polyether polyols include, e.g., polyalkylene glycols (e.g., polyethylene glycol, polypropylene glycol, polytetramethylene glycol, and combinations thereof), and other polyether polyols derived from the reaction product of a variety of polyols (e.g., ethylene glycol, propylene glycol, butane diol, hexane diol, glycerol, trimethylolethane, trimethylolpropane, pentaerythritol, cyclohexane dimethanol) and alkylene oxides (e.g., ethylene oxide, propylene oxide, and butylene oxide, and mixtures thereof), fluorinated polyether polyols, and combinations thereof.

Suitable commercially available polyether polyols are available under a variety of trade designations including. e.g., under the VORANOL series of trade designations including, e.g., VORANOL 220-56, VORANOL 220-110, VORANOL 220-260, VORANOL 230-56, VORANOL 230-110, and VORANOL 230-238 from Dow Chemical Co. (Midland, Mich.) and PLUROCOL 450 and PLUROCOL PEP 450, polyether polyols having a functionality of 4, commercially available from BASF Corporation (Wyandotte, MI).

Useful polyester polyols are prepared from the reaction product of polycarboxylic acids, their anhydrides, their esters or their halides, and a stoichiometric excess of polyhydric alcohol. Poly-carboxylic acids useful for forming polyester polyols include, e.g., dicarboxylic acids and tricarboxylic acids including, e.g., aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecartedicarboxylic acid, dimeric acid, dimerized fatty acids, trimeric fatty acids, and fumaric acid), alicyclic dicarboxylic acids (e.g., 1,3-cyclohexanedicarboxylic acid, and 1,4-cyclohexanedicarboxylic acid), and mixtures thereof.

Suitable polyhydric alcohols from which polyester polyols can be derived include aliphatic polyols (e.g., ethylene glycol, propane diols (e.g., 1,2-propanediol and 1.3-propanediol), butane diols (e.g., 1,2-butanediol, 1,3-butanediol, and 1,4-butanediol), 1,3-butenediol, 1,4-butenediol, 1,4-butynediol, pentane diols (e.g., 1,5-pentanediol), pentenediols, pentynediols, 1.6-hexanediol, 1,8-octanediol, 1,10-decanediol, neopentyl glycol, diethylene glycol, triethylene glycol, tetraethylene glycol, polyethylene glycols, propylene glycol, dipropylene glycol, tripropylene glycol, 1,4-cyclohexanedimethanol, 1,4-cyclohexanediol, dimer diols, glycerol, polytetramethylene ether glycol, 3-methyl-1,5-pentanediol, 1,9-nonanediol, 2-methyl-1,8-octaanediol, trimethylolpropane, pentaerythritol, sorbitol, glucose and mixtures thereof.

Based on 100% solids, the average OH number of the polyol (or blend of polyols) is from 25 to 500, 30 to 300, or even 50 to 200 as reported by the supplier.

Suitable commercially available polyester polyols are available under a variety of trade designations including. e.g., under the STEPANPOL series of trade designations including, e.g., BC180, PC1011-55, PC1011-210, PC-1017P-55, PC-1028P-210, PC-1040P-55, PC-107-110, PC-2011-225, PC-2019-55, PC-207-125, PC-5040-167, PC-5070P-56, PD-195, PD320, PDP-70, and PS-2002 from Stepan Company (Evansville, Ill.).

### Polyisocyanate

Polyisocyanates useful in the preparation of the polyurethane prepolymer have at least two isocyanate groups and include, e.g., aliphatic, cycloaliphatic, araliphatic, arylalkyl, alkylaryl, and aromatic isocyanates, monomeric isocyanates, oligomeric isocyanates, polymeric isocyanates, diisocyanates, triisocyanates, tetraisocyanates, carbodiimide modified isocyanates, allophanate modified isocyanates, biuret modified isocyanates, isocyanurate modified isocyanates, and mixtures thereof. Useful aromatic polyisocyanates include, e.g., diphenylmethane diisocyanate compounds (MDT) including its isomers, carbodiimide modified MDI, allophanate modified MDI, biuret modified MDI, diphenylmethane 4,4′-diisocyanate, diphenylmethane 2,2′-diisocyanate, diphenylmethane 2,4′-diisocyanate, oligomeric MDI, polymeric MDI, isomers of naphthalene diisocyanate, isomers of triphenylmethane triisocyanate, toluene diisocyanates (TDI) (e.g., 2,4-TDI and 2,6-TDI), and mixtures thereof.

Other suitable diisocyanates include, e.g., 1,3-cyclopentane diisocyanate, 1,4-cyclohexane diisocyanate, 1,3-cyclohexane diisocyanate, hydrogenated MDI (i.e., dicvclohexylmethane diisocyanate, H12-MDI), methyl 2,4-cyclohexanediisocyanate, methyl 2,6-cyclohexanediisocyanate, 1,4-bis(isocyanatomethyl)cyclohexane, 1,3-bis(isocyanatomethyl)cyclohexane, 4,4′-diphenyl diisocyanate, 4,4′-toluidine diisocyanate, dianilidine diisocyanate, 4,4′-diphenyl ether diisocyanate, 1,3-xylylene diisocyanate including 1,3-diisocyanato-o-xylene, 1,3-diisocyanato-p-xylene and 1.3-diisocyanato-m-xylene, 1,4 xylylene diisocyanate, omega,omega′-diisocyanato-1,4-diethylbenzene, isomers of tetramethylxylylene diisocyanate, dialkyldiphenylmethane diisocyanates, tetraalkyldiphenylmethane diisocyanates, 4,4′-dibenzyl diisocyanate, 1,3-phenylene diisocyanate, 1,4-phenylene diisocyanate, and mixtures thereof.

Examples of additional suitable diisocyanates include 1,2-diisocyanatoethane, 1,3-diisocyanatopropane, 1,2-diisocyanatopropane, 1,4-diisocyanatobutane, 1,5-diisocyanatopentane, 1,6-diissocyanatohexane (HDI) (i.e., hexamethylene diisocyanate) (e.g., 1,6-HDI and 2,6-HDI), biuret modified HDI, HDI dimer, HDI trimer, bis(3-isocyanatopropyl)ether, bis(3-isocyanatopropyl)sulfide, 1,7-diisocyanatoheptane, 1,5-diisocyanato-2,2-dimethylpentane, 1,6-diisocyanate-3-methoxyhexane, 1,8-diisocyanatoctane, 1,5-diisocyanato-2,2,4-trimethylpentane, 1,9-diisocyanatononane, 1,10-diisocyanatopropyl ether of 1,4-butylene glycol, 1,11-diisocyanatoundecane, 1,12-diisocyanatododecane, bis(isocyanatohexyl)sulfide, 2,4-diisocyanto-1-chlorobenzene, 2,4-diisocyanato-1-nitro-benzene, 2,5-diisocyanato-1-nitrobenzene, m-phenylene diisocyanate, 1-methoxy-2,4-phenylene diisocyanate, 1-methoxy-2,4-phenylene diisocyanate, 3,3′-dimethyl-4,4′-diphenylmethane diisocyanate, 1-methyl-2,4-diisocyanatocyclohexane, 1,6-diisocyanato-2,2,4-trimethylhexane, 1,6-di-isocyanato-2,4,4-trimethylhexane, I-isocyanatomethyl-3-isocyanato-1,5,5-trimethylcyclohexane (IPDI) (i.e., isophorone diisocyanate), IPDI dimer, IPDI trimer, isocyanurate modified IPDI, chlorinated and brominated diisocyanates, phosphorus-containing diisocyanates, 4,4′-diisocyanatophenylperfluoroethane, tetramethoxybutane-1,4-diisocyanate, bisisocyanatoethyl phthalate; polyisocyanates containing reactive halogen atoms 1-chloromethylphenyl-2,4-diisocyanate, 1-bromoethylphenyl-2,6-diisocyanate, and 3,3-bischloromethyl ether-4,4′-diphenyldiisocyanate); sulfur-containing polyisocyanates; dimeric fatty acid diisocyanates, and combinations thereof.

Examples of suitable triisocyanates include 4,4′,4″-triphenylmethane triisocyanate and 2,4,6-toluene triisocyanate. One example of a tetraisocyanates is 4,4′-dimethyl-2,2′-5,5′-diphenylmethane tetraisocyanate. Another suitable isocyanate is polymethylene polyphenylene polyisocyanate.

Useful commercially available isocyanates are available under a variety of trade designations including, e.g., under the RUBINATE and SUPRSEC series of trade designations including, e.g., RUBINATE M, RUBINATE 1285 (polymeric MDI), RUBINATE 44, SUPRASEC 2004 MDI, SUPRASEC 1680, and SUPRUSEC 9561 (carbodiimide modified MDI) from Huntsman (Freeport, Tex.), and the TOLONATE series of trade designations including. e.g. TOLONATE HDT and TOLONATE HDB from Vencorex (Freeport, Tex.), and the VESTANAT series of trade designations including, e.g., VESTANAT T 1890/100 and VESTANAT I from Evonik (Parsippany, N.J.).

### Epoxy Resin

The second part includes an epoxy resin. As used herein, the term epoxy resin includes adducts derived from an epoxy resin. In an epoxy resin adduct, the epoxy resin includes a small amount of a material (e.g., amine) that reacts with the epoxy resin. This allows the epoxy resin to begin to cure and further forms another hydroxy group, before the first part and second part are mixed. The epoxy resin can be a solid at room temperature.

The epoxy resin has an equivalent weight of at least 300 grams/equivalence (g/eq), at least 350 g/eq, at least 400 g/eq, from 300 g/eq to 4000 g/eq, from 400 g/eq to 3,000 g/eq, or even 500 g/eq to 3,000 g/eq as reported by the supplier and tested according to ASTM D1652.

The epoxy resin has both epoxy and hydroxyl functionality. It is important that the equivalent weight of the epoxy resin is high enough to allow for an OH functionality of at least 2, or even greater than 2. This enables the OH groups of the epoxy resin to react with the isocyanate terminated prepolymer and become incorporated into the polyurethane adhesive composition. The epoxy resin can have an epoxy functionality of at least 2.

The epoxy resin can be derived from a liquid epoxy and an aromatic compound. The liquid epoxy can be selected from an epichorohydrin and an epichlorohydrin adduct. The aromatic compound can be selected from bisphenol A, bisphenol F, bisphenol AF, bisphenol S, bisphenol B, bisphenol Z, novalac, cresol novalac, etc.

Common adducts of the epoxy resin include the epoxy resin reacted with an amine (e.g., diethanol amine, etc.).

The second part comprises at least 10% by weight, at least 15% by weight, at least 20% by weight, greater than 20% by weight, from 10% by weight to 80% by weight, from 15% by weight to 80% by weight, from 20% by weight to 70% by weight, from 22% by weight to 70% by weight, from 25% by weight to 70% by weight, or even from 30% by weight to 65% by weight of the epoxy resin based on the total weight of the second part.

Suitable epoxy resins are commercially available under the trade designation EPON, including e.g., EPON 1002, EPON 1004 and EPON 1007 available from Hexion Inc.

### Solvent

The polyurethane adhesive composition can include a solvent in the first part, the second part, or in both the first and second parts. The solvent can be selected from the group consisting of acetone, ketone, methyl ethyl ketone, methyl isobutyl ketone, aromatic hydrocarbons (e.g. toluene, xylene, etc.), hexane, heptane, cyclohexane, other aliphatic hydrocarbon/alicyclic hydrocarbons, dioxane, tetrahydrofuran, ethers, methyl acetate, ethyl acetate, butyl acetate, isobutyl acetate esters such as N, N-dimethylformamide, N, N-dimethylacetamide, N-methyl pyrrolidone and blends thereof.

### Additives

The polyurethane adhesive composition optionally includes additional components including, e.g., additional epoxies, stabilizers, antioxidants, adhesion promoters (e.g., silanes, epoxy modified materials (e.g. aromatic modified epoxy materials), aromatic adhesion promoters, functionalized adhesion promoters, etc.), ultraviolet light stabilizers, theology modifiers, colorants (e.g., pigments and dyes), fillers, surfactants, flame retardants, catalysts (e.g., organo tin catalysts (e.g., dibutyl tin dilaurate), organo bismuth catalysts, and organo zinc catalysts), additional polyols (e.g. higher functionality/branched polyols), organic solvent, and combinations thereof.

Useful additives include those available under the HYPOX trade designations, including HYPOX RA840, a high-viscosity adduct of the diglycidyl ether of bisphenol A and a butadiene-acrylonitrile elastomer, from Huntsman Advance Materials (Basel, Switzerland).

### Second Adhesive Composition

The laminate can include a second adhesive composition. The second adhesive composition can be used to form a bond between the metal layer and the second plastic layer, or between additional layers of the flexible laminate.

The second adhesive composition can be different from the polyurethane adhesive composition or the same as the polyurethane adhesive composition.

The second adhesive composition can be a two-part polyurethane adhesive comprising a first part including a polyol and a second part including a polyisocyanate.

### Method of Use

The polyurethane adhesive composition is formed by combining the first part, which includes the polyurethane prepolymer, and the second part, which includes an epoxy resin. The polyurethane adhesive composition can be supplied as a two-part adhesive composition in two different containers. The polyurethane adhesive composition can be supplied in the form of a two-part solvent-based adhesive composition.

The invention includes a method of making a flexible laminate including obtaining a polyurethane adhesive composition including a first part comprising an isocyanate terminated polyurethane prepolymer and a solvent, and a second part comprising an epoxy resin having an equivalent weight of at least 300 g/eq and a solvent, mixing the first part and the second part of the polyurethane adhesive composition together, applying the polyurethane adhesive to a substrate selected from the first plastic layer and the metal layer, laminating the remaining substrate into place, such that the metal layer is bonded to the plastic layer through the polyurethane adhesive composition.

The flexible laminate of this invention is useful for forming the outer covering (e.g. pouch) of energy storage devices e.g. batteries e.g. lithium ion batteries used in for example e.g. electric vehicles, hybrid electric vehicles, personal computers, cameras, mobile telephones, etc. The flexible laminate comprising the polyurethane adhesive composition of this invention is also useful for packaging vehicle fluids (e.g. oil, hydraulic fluid, brake fluid, etc.), medical compositions (e.g. iodine swabs) and other chemicals.

The polyurethane adhesive composition can be applied to the substrates using any suitable technique including, e.g., intermittent coating, continuous coating, air knife, trailing blade, spraying, brushing, dipping, doctor blade, roller coating (e.g., smooth roll), gravure coating (e.g., direct gravure, reverse gravure, offset gravure, and rotogravure), engraved roller coating, wheel coating, contacting coating, transfer coating (e.g., multi-roll transfer coating), flexographic coating, and combinations thereof.

### Packaged Energy Storage Device

The invention features a packaged energy storage device. The packaged energy storage device can include a lithium ion battery enclosed within the claimed flexible laminate. This type of packaged lithium ion battery is commonly referred to as a pouch battery. The flexible laminate forms a pouch in which the components of the battery are contained.

The packaged lithium ion battery can include a lithium-ion battery, and a pouch surrounding the lithium-ion battery, the pouch includes a flexible laminate comprising a first plastic layer, a polyurethane adhesive composition, a metal foil layer, a second adhesive composition, and a second plastic layer arranged in sequence from the outward facing side of the package to the interior facing side of the package, the polyurethane adhesive composition includes the reaction product of a first part comprising an isocyanate terminated polyurethane prepolymer, and a second part comprising an epoxy resin having an equivalent weight of at least 300 g/eq.

The lithium ion battery can comprise a lithium metal oxide cathode, an anode, a separator and an electrolyte. All the components of the lithium ion battery can be enclosed within the flexible laminate.

The flexible laminate preferably includes a first plastic layer comprising nylon, a metal foil layer comprising aluminum and a second plastic layer comprising polypropylene.

The pouch can be formed by heat sealing two portions of the flexible laminate along the outside perimeter with the second plastic layers facing each other.

The invention will now be described by way of the following examples. All parts, ratios, percentages and amounts stated in the Examples are by weight unless otherwise specified.

### Examples

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Percentage Isocyanate (NCO) Test Method

The percentage isocyanate (% NCO) is determined according to ASTM D-2572-19.

### 180° Peel Adhesion Test Method

The 180° peel adhesion was determined by testing a laminate using either a Thwing-Albert Friction/Peel Tester Model 225-1 (tested at 23° C.) or a Instron testing machine equipped with a chamber (tested at 80° C. and 120° C.).

The laminates were made by hand. The adhesive was applied using a drawn down bar to obtain the listed coat weight, the solvent was flashed off in the oven at 50° C. for 90 seconds and then laminated with the second substrate. A 2-kg roller to was then rolled over the laminate to form the bond.

The laminate was prepared by applying 5 grams/square meter (g/m2) of the polyurethane adhesive composition to be tested to a 36-micron thick aluminum foil (AF) substrate. The coated aluminum foil was then laminated to second substrate that is a 12-micron thick bioriented polyamide (PA) film as described above. A second layer of the same polyurethane adhesive composition at the same coat weight was then applied to the opposite side of the aluminum foil and a 70-micron cast polypropylene (CPP) was laminated it.

The final lamination was a five-layer lamination (as seen in FIG. 2) with the polyurethane adhesive composition between the layers and the aluminum foil as the middle layer.

The laminate was then allowed to cure at either 23° C. and a relative humidity (RH) of 50% or 50° C. and room temperature humidity. Cure conditions are noted in the table.

At least 7 days after the laminate was prepared the laminate was cut into 25 millimeter (mm)×250 mm sample strips. Each sample strip is separated at one end and the end of the first substrate (i.e., the bioriented polyamide film or cast polypropylene film) is placed in the moving part of the peel tester and the end of the second substrate (i.e., the aluminum foil film) is placed in the stationary part of the peel tester. The film layer is peeled at a rate of 5 mm/second for 10 seconds. The peel strength in is recorded as 180° Peel adhesion in units of N/15 mm. The average 180° Peel adhesion of three (3) samples is reported.

TABLE ONE
The amounts listed below are for the polyurethane adhesive
composition i.e. after the two parts are combined.

| | Comp | Comp | Comp | Example | Example | Example |
|---|---|---|---|---|---|---|
| | 1 | 2 | 3 | 1 | 2 | 3 |
| Cure Conditions | 23° C. | 23° C., | 23° C., | 23° C., | 50° C., RT | 35°, RT |
| | 50% RH | 50% RH | 50% RH | 50% RH | Humidity | Humidity |
| Prepolymer 1 | 100 | 100 | 100 | 100 | 100 | 100 |
| (grams) | | | | | | |
| Ethyl Acetate | 83.2 | 71.6 | 72.8 | 84.6 | 84.6 | 65 |
| (grams) | | | | | | |
| CARDOLITE NX- | 13.5 | | | | | |
| 9005 (grams) | | | | | | |
| PLURACOL PEP | | 4 | 2.5 | | | |
| 450 (grams) | | | | | | |
| POLYCIN M-365 | | | 2.5 | | | |
| (grams) | | | | | | |
| HYPOX RA840 | | | | | | 3.5 |
| (grams) | | | | | | |
| EPON 1002 | | | | 14.7 | 14.7 | |
| (grams) | | | | | | |
| EPON 1004 | | | | | | 11.5 |
| (grams) | | | | | | |
| % Solids (mixture) | 45% | 45% | 45% | 45% | 45% | 50% |
| NCO/OH Ratio | 1.5/1.0 | 1.56/1.0 | 1.5/1.0 | 1.5/1.0 | 1.5/1.0 | 1.5/1.0 |
| Polyol | 3 | 4 | >4 | 4 | 4 | 1 |
| Functionality | | | | | | |
| PA/Foil bond tested | 4.7 | 4.5 | 4.4 | 5.5 | 6.2 | 8.4 |
| at 23° C. (N/15 mm) | | | | | | |
| PA/Foil bond tested | 3.1 | 2.4 | 2.3 | >3.4 | >6.0 | >4 |
| at 80° C. (N/15 mm) | | | | | | |
| PA/Foil bond tested | 1.56 | 0.91 | 0.87 | 3.4 | >6, PA | >3 |
| at 120° C. (N/15 mm) | | | | | tear | |
| Foil/CPP bond tested | 9.1 | 10.6 | 7.5 | >25 | >25 | >12 |
| at 23° C. (N/15 mm) | | | | | | |
| Foil/CPP bond tested | >10 | >10 | >10 | >10 | >10 | >10 |
| at 80° C. (N/15 mm) | | | | | | |

Prepolymer 1 is an isocyanate terminated prepolymer derived from predominantly polyether polyol and having a NCO/OH ratio of 1.4/1.0 with a % NCO of 2.1-2.6 and a calculated solids content of 75% by weight.
Comp 1, 2 and 3 show alternate approaches utilizing branched/higher functionality polyols. These approaches did provide adequate bonds

What is claimed is:

1. A flexible laminate comprising:
a first plastic layer,
a polyurethane adhesive composition, and
a metal layer bonded to the first plastic layer through the polyurethane adhesive composition,
the polyurethane adhesive composition comprising a reaction product of:
a first part comprising an isocyanate terminated polyurethane prepolymer, the isocyanate terminated polyurethane comprising the reaction product of a polyol component and a polyisocyanate, where the polyol component comprises greater than 50% by weight of polyether polyol, and
a second part comprising greater than 20% by weight based on the weight of the second part of an epoxy resin having an equivalent weight of at least 300 g/eq.

2. The flexible laminate of claim 1 comprising:
from 75% by weight to 90% by weight of the isocyanate terminated polyurethane prepolymer, and
from 10% by weight to 25% by weight of the epoxy resin, wherein the weight percentages are based on 100% solids.

3. (canceled)

4. The flexible laminate of claim 1 wherein the polyurethane adhesive composition has an NCO:OH ratio of from 3:1 to 1.1:1

5. The flexible laminate of claim 1 wherein the polyurethane adhesive composition has an NCO:OH ratio of from 2:1 to 1.1:1

6. The flexible laminate of claim 1 wherein the epoxy resin is aromatic and has an epoxy functionality of at least 2.

7. The flexible laminate of claim 1 wherein the epoxy resin is aromatic and has an epoxy functionality of at least 2, and further has an OH functionality of greater than 2.

8. The flexible laminate of claim 1 wherein the epoxy is a solid at room temperature and is derived from a liquid epoxy and bisphenol A.

9. The flexible laminate of claim 1 wherein the metal layer is selected from the group consisting of aluminum, aluminum alloys, stainless steel, copper and titanium.

10. The flexible laminate of claim 1 wherein the first plastic layer is selected from the group consisting of polyamide, polyimide, polyester, epoxy, acrylic, fluoropolymers, polyurethane, silicone, phenolic resin, polycarbonate, and copolymers thereof.

11. The flexible laminate of claim 1 wherein the first plastic layer is nylon and the metal layer is an aluminum foil.

12. A package comprising the flexible laminate of claim 1, the flexible laminate, comprising the first plastic layer, the polyurethane adhesive composition layer, the metal layer, a second adhesive composition, and a second plastic layer arranged in sequence from the outside to the inside of the package.

13. A package formed from the flexible laminate of claim 1.

14. A package comprising the flexible laminate of claim 1 and an energy storage device.

15. A packaged lithium-ion battery comprising:
a lithium-ion battery, and
a pouch surrounding the lithium-ion battery, the pouch comprising a flexible laminate comprising a first plastic layer, the polyurethane adhesive composition of claim 1, a metal foil layer, a second adhesive composition, and a second plastic layer arranged in sequence from the outside to the inside.

16. The flexible laminate of claim 1 wherein the polyol has an average OH number based on 100% solids of the polyol of from 50 to 200.
